(19) United States
(12) Patent Application Publication
(10) Pub. No.: US 2014/0092900 A1
(43) Pub. Date: Apr. 3, 2014

(54) METHODS AND APPARATUSES TO SPLIT INCOMING DATA INTO SUB-CHANNELS TO ALLOW PARALLEL PROCESSING

(71) Applicants: James W. Kisela, Snohomish, WA (US); Steve Koller, Yorktown, NY (US); William Winston, Lake Stevens, WA (US); Dan Prescott, (US); Robert Vogt, Colorado Springs, CO (US)

(72) Inventors: James W. Kisela, Snohomish, WA (US); Steve Koller, Yorktown, NY (US); William Winston, Lake Stevens, WA (US); Dan Prescott, (US); Robert Vogt, Colorado Springs, CO (US)

(21) Appl. No.: 13/631,776

(22) Filed: Sep. 28, 2012

(51) Int. Cl. H04L 12/56

(52) U.S. Cl. 370/389

(57) ABSTRACT

Exemplary embodiments of methods and apparatuses to split incoming data into a plurality of sub-channels to allow parallel processing are described. A packet is received over a network. The packet is compared against a filter. The packet is routed to a process sub-channel in a memory based on the comparing. The process sub-channel is one of the plurality of process sub-channels that are configured to allow parallel processing. In one embodiment, the filter includes user defined criteria for the packet.

### FIELD

At least some embodiments of the present invention generally relate to networking, and more particularly, to splitting incoming data into sub-channels to allow parallel processing.

### BACKGROUND

Generally, to monitor and troubleshoot network operations, network traffic packets are captured and analyzed. The amount of data that need to be captured and analyzed can be large in high speed, high traffic volume networks. Because of the large amount of data to analyze and how much computation needs to be done on each packet, a single central processing unit (CPU) core having a limited processing capability cannot handle all of the data needed.

Further, as the network speeds increase it becomes more and more difficult to keep up with the incoming data traffic and analyze the data in a timely manner that reduces network analysis efficiency.

### SUMMARY OF THE DESCRIPTION

Exemplary embodiments of methods and apparatuses to split incoming data into a plurality of sub-channels to allow parallel processing are described. A packet is received over a network. The packet is compared against a filter. The packet is routed to a process sub-channel in a memory based on the comparing. The process sub-channel is one of the plurality of process sub-channels that are configured to allow parallel processing. In one embodiment, the filter includes user defined criteria for the packet.

Other features of the present invention will be apparent from the accompanying drawings and from the detailed description which follows.

### BRIEF DESCRIPTION OF DRAWINGS

The embodiments as described herein are illustrated by way of example and not limitation in the figures of the accompanying drawings in which like references indicate similar elements.

FIG. 1 is a block diagram illustrating a data processing system according to at least some embodiments of the invention.

FIG. 2 is a block diagram of a network system according to at least some embodiments of the invention.

FIG. 3 is a block diagram of an apparatus according to at least some embodiments of the invention.

FIG. 4 illustrates a data structure containing network traffic filters according at least some embodiments of the invention.

FIG. 5 shows an exemplary diagram illustrating a packet according to at least some embodiments of the invention.

FIG. 6 is an exemplary flowchart of a method to split incoming data into a plurality of sub-channels according to at least some embodiments of the invention.

FIG. 7 shows an exemplary sub-channel mapping for one of the logical channels according to at least some embodiments of the invention.

### DETAILED DESCRIPTION

Exemplary embodiments of methods and apparatuses to split incoming data into a plurality of sub-channels to allow parallel processing are described. Exemplary embodiments of the invention described herein address a high-speed way to distribute a processing load across multiple processors and/or processes.

A packet is received over a network. The packet is compared against a filter. In at least some embodiments, the filter is a network traffic filter. The packet is routed to a process sub-channel in a memory based on the comparing. In at least some embodiments, the packet is compared with the filter. The filter is one of a plurality of filters stored in the memory. The filter matched to the packet is selected from the plurality of filters. In at least some embodiments, the filter includes user defined criteria for the packet. In at least some embodiments, the process sub-channel is one of the plurality of process sub-channels that are configured to allow parallel processing of incoming packet data.

In at least some embodiments, a hash value of at least a portion of the packet is determined. The process sub-channel for the packet data is selected based on the hash value. In at least some embodiments, a network interface at which the packet has been received is determined. A logical channel in a memory corresponding to the network interface is determined for the packet data.

In at least some embodiments, the incoming data stream is split by a network controller that can be, for example, a high performance 1 Gigabit (G) and/or 10 G Ethernet capture card, into multiple data streams (e.g., channels, sub-channels). Splitting the incoming data stream into multiple streams allows parallel processing of the data using, for example, multiple CPUs. In at least some embodiments, the incoming packet data stream is split into sub-channels based on information contained in each packet. In at least some embodiments, the incoming packet data stream is split into sub-channels based on a set of user defined filter criteria (e.g., extended by Berkeley Packet Filters (BPFs) syntax) allowing for increased parallelization and a decrease in processing capacity required to handle increased data rates.

In at least some embodiments, as packets come into a capture card, each packet is tagged for the information including at least one of which port it came in on, which server filters it matches, destined for region A, B or C, and hash of the packets IP address, as described in further detail below. In at least some embodiments, based on this information the packet is routed to a sub-channel that is assigned to at least one of a unique processing core and a process to process and/or analyze.

In at least some embodiments, the filter is a network traffic filter that is generated based on a set of enhanced Berkeley Packet Filters (BPFs) to segment network traffic into different regions, with each region receiving a different level or analysis, as described in further detail below. In at least some embodiments, each packet processed by a network analyzing system is compared against a set of BPFs. Based on the filter that is matched, a packet is assigned to a single region in a memory, as described in further detail below.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention. Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Unless specifically stated otherwise, it is appreciated that throughout the description, discussions utilizing terms such as “processing” or “computing” or “calculating” or “determining” or “displaying” or the like, refer to the action and processes of a data processing system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g.; computer) readable storage medium, such as, but is not limited to, any type of disk, including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a bus.

The algorithms and displays presented herein are not inherently related to any particular computer or other apparatus. Various general-purpose systems may be used with programs in accordance with the teachings herein, or it may prove convenient to construct more specialized apparatus to perform the required machine-implemented method operations. The required structure for a variety of these systems will appear from the description below.

In addition, embodiments of the present invention are not described with reference to any particular programming language. It will be appreciated that a variety of programming languages may be used to implement the teachings of embodiments of the invention as described herein.

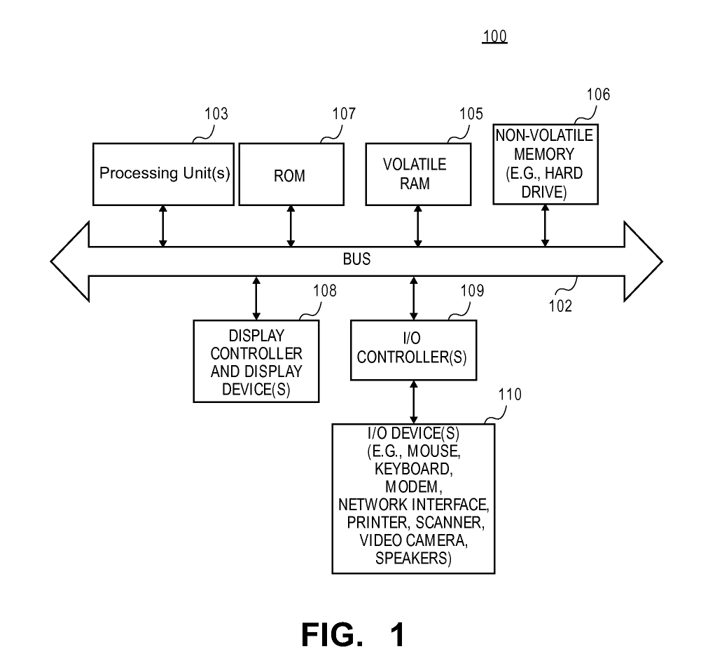

FIG. 1 shows one example of a data processing system which may be used with the embodiments of the present invention. Note that while FIG. 1 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

Generally, a network refers to a collection of computers and other hardware components interconnected to share resources and information. Networks may be classified according to a wide variety of characteristics, such as the medium used to transport the data, communications protocol used, scale, topology, and organizational scope. Communications protocols define the rules and data formats for exchanging information in a computer network, and provide the basis for network programming. Well-known communications protocols include Ethernet, a hardware and link layer standard that is ubiquitous in local area networks, the Internet protocol (IP) suite, which defines a set of protocols for internetworking, i.e. for data communication between multiple networks, as well as host-to-host data transfer e.g., Transmission Control Protocol (TCP), and application-specific data transmission formats, for example, Hypertext Transfer Protocol (HTTP), a User Datagram Protocol (UDP), Voice over Internet Protocol (VoIP). Methods and apparatuses to split incoming data into a plurality of sub-channels described herein can be used for any of networks, protocols, and data formats.

As shown in FIG. 1, the data processing system 100, which is a form of a data processing system, includes a bus 102 which is coupled to one or more processing units 103, a ROM 107, volatile RAM 105, and a non-volatile memory 106. One or more processing units 103, may include, for example, a G3 or G4 microprocessor from Motorola, Inc. or IBM, may be coupled to a cache memory (not shown). The bus 102 interconnects these various components together and also interconnects these components 103, 107, 105, and 106 to a display controller and display device(s) 108 and to peripheral devices such as input/output (I/O) devices which may be mice, keyboards, modems, network interfaces, printers, scanners, video cameras, speakers, and other devices which are well known in the art. Typically, the input/output devices 110 are coupled to the system through input/output controllers 109. The volatile RAM 105 is typically implemented as dynamic RAM (DRAM) which requires power continually in order to refresh or maintain the data in the memory. The non-volatile memory 106 is typically a magnetic hard drive or a magnetic optical drive or an optical drive or a DVD RAM or other type of memory systems which maintain data even after power is removed from the system. Typically, the non-volatile memory will also be a random access memory although this is not required. In at least some embodiments, data processing system 100 includes a power supply (not shown) coupled to the one or more processing units 103 which may include a battery and/or AC power supplies.

While FIG. 1 shows that the non-volatile memory is a local device coupled directly to the rest of the components in the data processing system, it will be appreciated that the embodiments of the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 109 includes a USB (Universal Serial Bus) adapter for controlling USB peripherals, and/or an IEEE-1394 bus adapter for controlling IEEE-1394 peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, volatile RAM 105, non-volatile memory 106, or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by one or more processing units 103, e.g., a microprocessor, and/or a microcontroller.

A machine readable medium can be used to store software and data which when executed by a data processing system causes the system to perform various methods of the present invention. This executable software and data may be stored in various places including for example ROM 107, volatile RAM 105, and non-volatile memory 106 as shown in FIG. 1. Portions of this software and/or data may be stored in any one of these storage devices.

Thus, a machine readable medium includes any mechanism that provides (i.e., stores and/or transmits) information in a form accessible by a machine (e.g.; a computer, network device, cellular phone, personal digital assistant, manufacturing tool, any device with a set of one or more processors, etc.). For example, a machine readable medium includes recordable/non-recordable media (e.g., read only memory (ROM); random access memory (RAM); magnetic disk storage media; optical storage media; flash memory devices; and the like.

The methods of the present invention can be implemented using a dedicated hardware (e.g., using Field Programmable Gate Arrays (FPGAs), or Application Specific Integrated Circuit (ASIC) or shared circuitry (e.g., microprocessors or microcontrollers under control of program instructions stored in a machine readable medium). The methods of the present invention can also be implemented as computer instructions for execution on a data processing system, such as system 100 of FIG. 1.

Generally, a FPGA is an integrated circuit designed to be configured by a customer or a designer after manufacturing. The FPGA configuration is generally specified using a hardware description language (HDL). FPGAs can be used to implement a logical function.

FPGAs typically contain programmable logic components (“logic blocks”), and a hierarchy of reconfigurable interconnects to connect the blocks. In most FPGAs, the logic blocks also include memory elements, which may be simple flip-flops or more complete blocks of memory.

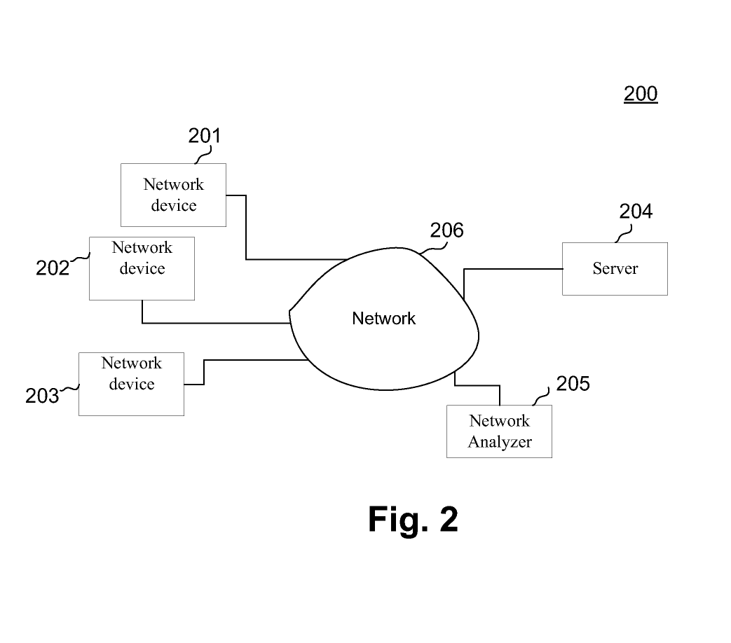

FIG. 2 is a block diagram of a network system according to at least some embodiments of the invention. As shown in FIG. 2, a network system 200 comprises network devices, such as network devices 201, 202, and 203, a server 204 which communicate over a network 206 by sending and receiving network traffic. The traffic may be sent in a packet form, with varying protocols and formatting thereof. As shown in FIG. 2, a network analyzer 205 is also connected to the network 206. Network analyzer 205 can include a remote network analyzer interface (not shown) that enables a user to interact with the network analyzer to operate the analyzer and obtain data therefrom remotely from the physical location of the analyzer. The network analyzer comprises hardware and software, CPU, memory, interfaces and the like to operate to connect to and monitor traffic on the network, as well as performing various testing and measurement operations, transmitting and receiving data and the like. The remote network analyzer typically is operated by running on a computer or workstation interfaced with the network.

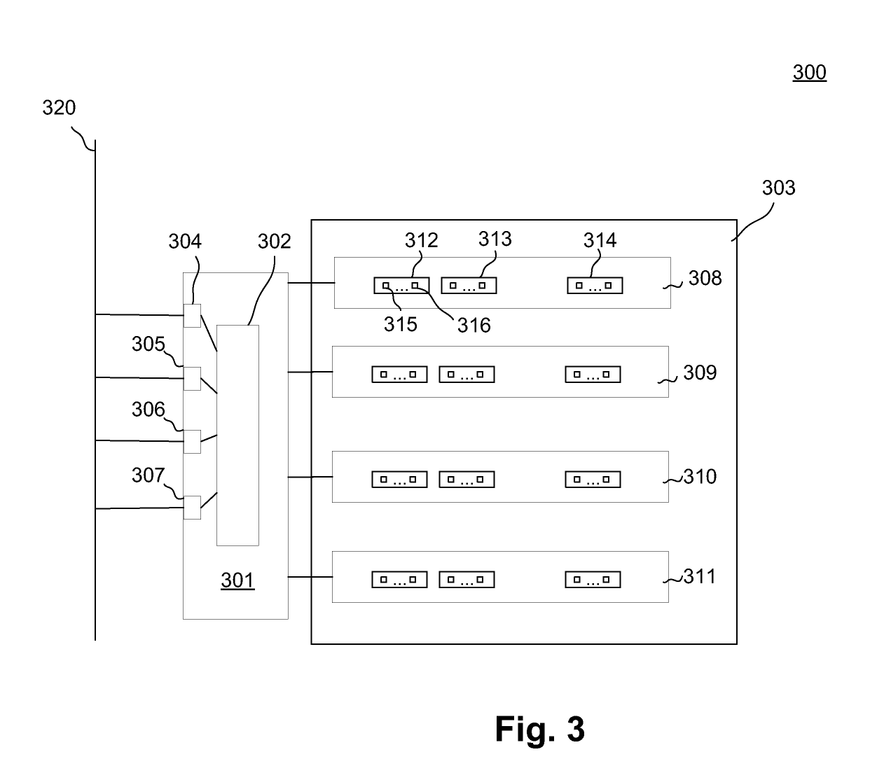

FIG. 3 is a block diagram 300 of an apparatus to split incoming data into a plurality of sub-channels according to at least some embodiments of the invention. As shown in FIG. 3 an apparatus includes a network processing unit 302 on a high-performance data processing system 301. In at least some embodiments, data processing system 301 is a data processing system 100, as depicted in FIG. 1. In at least some embodiments, data processing system 301 is a network analyzer, such as network analyzer 205 depicted in FIG. 2. In at least some embodiments, data processing system 301 is an application performance analyzer, e.g., an Application Performance Appliance (APA) produced by Fluke Networks, Inc. located in Everett, Wash. In at least some embodiments, network processing unit 302 includes a network interface controller to connect to a computer network. In at least some embodiments, network processing unit 302 is a high performance (e.g., 1 G, 10 G, or both) Ethernet capture card. In at least some embodiments, network processing unit 302 is a network capture card including a FPGA that plugs, for example, into a Peripheral Component Interconnect Express (PCIe) slot in a high-performance data processing system, to capture traffic over a network, such as network 206.

In at least some embodiments, a network processing unit, such as network processing unit 302, reads the data to be analyzed off the network. The network processing unit is configured to look at the data and depending on certain characteristics, the network processing unit writes data to process sub-channels, which in the end, end up in different segments within a memory architecture of the system. In at least some embodiment, different processors or cores are assigned to the different memory segments so that each core or processor has its own data set to work with.

As shown in FIG. 3, data processing system 301 has plurality of network interfaces, such as interfaces 304, 305, 306, and 307. As shown in FIG. 3, data processing system 301 is coupled to a memory structure 303. In at least some embodiments, memory structure 303 is located at a data processing system 301. In at least some embodiments, memory structure 303 is distributed throughout a network, such as network 206. As shown in FIG. 3, memory structure 303 has sections of memory sized according to usage, such as sections 308, 309, 310, and 311. One or more physical network interfaces can be mapped into a logical channel. A logical channel is assigned a section of memory. The amount of memory assigned is based on the number of network interfaces in the logical channel and expected network traffic rate.

In at least some embodiments, network processing unit 302 is configured to receive a packet via one of network interfaces, e.g., network interfaces 304, 305, 306, and 307. In at least some embodiments, each logical channel of memory structure 303 can be mapped to corresponding one or more network interfaces. For example, the logical channel assigned to section 308 can be mapped to network interface 304, the logical channel assigned to section 309 can be mapped to network interface 305, the logical channel assigned to section 310 can be mapped to network interface 307, and the logical channel assigned to section 311 can be mapped to network interface 306. Many combinations are possible. The number and size of memory sections is variable depending on need and network traffic rates.

In at least some embodiments, a logical channel is mapped to a single network interface. In at least some embodiments, a logical channel is mapped to multiple network interfaces. In at least some embodiments, at least one of the logical channels is mapped to a single network interface, and at least one of the logical channels is mapped to multiple network interfaces.

In at least some embodiments, the network processing unit 302 is configured to determine a network interface of the packet. The processing unit 302 is further configured to determine a memory section based on the network interface and packet content filter criteria.

As shown in FIG. 3, each logical channel has logical regions, such as regions 312, 313, and 314. Each logical region has process sub-channels. Each sub-channel uses a portion of the memory section assigned to its logical channel, such as 315 and 316. In at least some embodiments, the process sub-channels are configured to allow parallel processing. In at least some embodiments, the data in the sub-channels are processed by different CPU cores. For example, data in sub-channel 315 can be processed by a first CPU core, and data sub-channel 316 can be processed by a CPU core other than the first CPU core. In at least some embodiments, the data in the sub-channels are associated with different processes that are performed by the same CPU core. For example, sub-channel 315 can be configured to store the data for a first process, and sub-channel 316 can be configured to store data for a process other than the first process.

In at least some embodiments, each logical region, such as each of regions 312, 313, and 314, is mapped to a network traffic filter. In at least some embodiments, the network traffic filter is one of a plurality of filters stored in a memory of the data processing system. In at least some embodiments, a Berkley Packet Filter (BPF) provides a standard syntax that is used to specify the network traffic filter. In at least some embodiments, a custom interpreter of BPF strings is used to provide a standard mechanism (programming API) for configuring the hardware of the network unit, such as network unit 302. In at least some embodiments, user criteria are defined using a BPF and then the BPF containing the user criteria is translated to configure the hardware. In at least some embodiments, the user defined criteria indicate a protocol associated with the packet, a server for the packet, a network interface, and what a user requests to do with the packet, for example, analyze, capture, or both. In at least some embodiments, the user defined criteria specify a range of IP addresses, a range of port numbers, a range of protocols, and the like. In at least some embodiments, the user defined criteria indicate the logic regions in memory.

In at least some embodiments, network traffic filters are set up to point to corresponding logic regions in a memory. For example, if a packet comes in and matches a filter that filter will provide a tag that would correlate to a specific region in memory. In at least some embodiments the filter is configured to provide a tag that specifies one of at least three regions A, B and C. In one embodiment, the network unit, such as network unit 302 has two to four interfaces through which Ethernet traffic comes in, and each of the interfaces is mapped to one of up to four logical channels, depending upon how many ports the network unit has. For example, if the network processing unit 302 has four ports, these ports can be mapped up to four logical channels. In at least some embodiments, a hash value in the packet report is created by the network unit, such as network processing unit 302, that points to a sub-region within the logical region. In at least some embodiments, up to three hash bits on the packet report can point to up to eight different process sub-regions. In at least some embodiments, the logical channels, logical regions, and sub-regions are combined to create a number of sub-channels to route the packet by the network unit, such as network processing unit 302. In at least some embodiments, a number of process sub-channels depends on a configuration. A number of sub-channels can be, for example, from 1 to 48 depending on the configuration, e.g., a memory configuration, hash bits used, a number of logical channels, and a number of network interfaces defined per logical channel. The filters can be defined to work against all network interfaces or any particular network interface depending on a configuration.

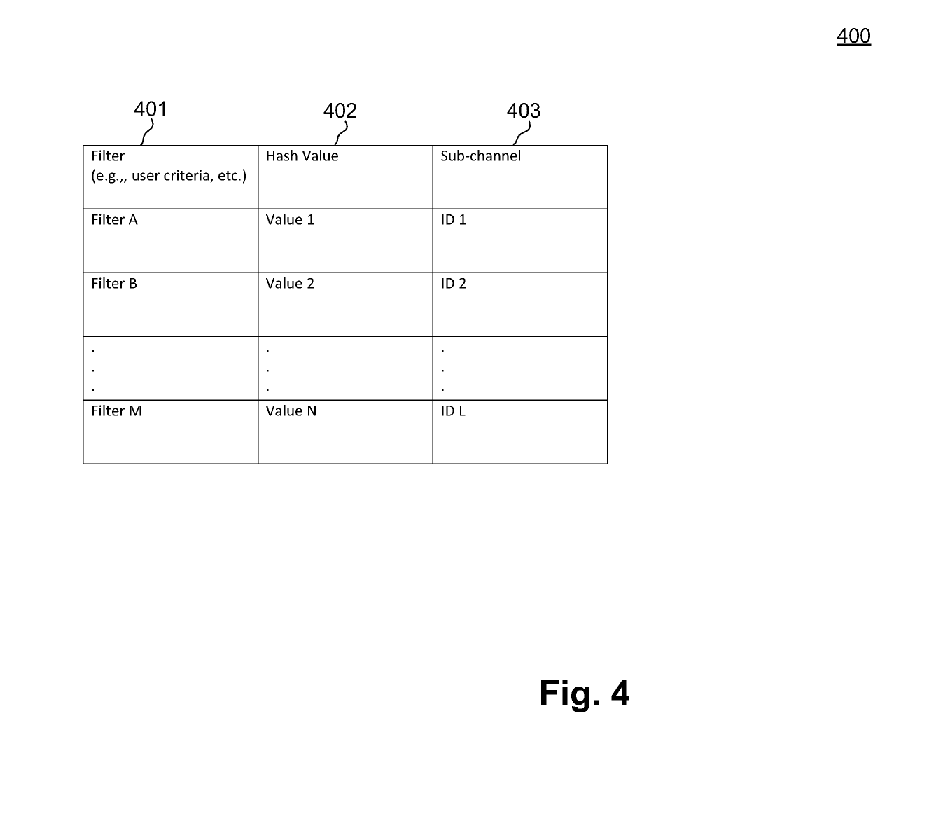

FIG. 4 illustrates a data structure 400 containing network traffic filters according at least some embodiments of the invention. As shown in FIG. 4, data structure 400 has a column 401 including network traffic filter data, such as filter A, filter B, and filter M. In at least some embodiments, a filter includes one or more conditions. For example, one or more conditions can indicate that a packet to and/or from a predetermined address on a network interface needs to go to a region A, and/or other conditions. In at least some embodiments, the filter data include user defined criteria. In at least some embodiments, the user defined criteria include data indicating an action to be performed on the data. For example, Filter data 1, can indicate a user request to capture the packet data, Filter data 2 can indicate a user request to analyze the packet data. Filter data M can indicate a user request to perform both capturing and analyzing the data. In at least some embodiments, user defined criteria include data indicating an address, a level of analysis to be performed on the data, a network interface for the data, and other user defined criteria. Data structure 400 has a column 402 including hash value data, such as Value 1, Value 2, and Value N. Data structure 400 has a column 403 including data identifying sub-channels corresponding to filter data and hash value data, such as data identifying a sub-channel 1 (ID1), a sub-channel 2 (ID 2); sub-channel L (ID L). As shown in FIG. 4, sub-channel 1 is mapped to a hash value 1, and filter 1, sub-channel 2 is mapped to a hash value 2, and filter 2, and sub-channel L is mapped to a hash value N, and filter M.

In at least some embodiments the sub region count, is configurable to be, for example, one, two, four or eight. In at least some embodiments, a network unit, such as network processing unit 302 analyzes information in the IP packet header to determine a hash by using which the network unit can then extract hash bits, for example three bits, which can steer the packet to a corresponding sub region of region A to write these data to. In at least some embodiments, the filter specifies the logical region, the interface to which the packet comes on and user conditions. In at least some embodiments, the network unit, such as network processing unit 302 determines a sub region to which to steer the packet based on a count of sub-regions.

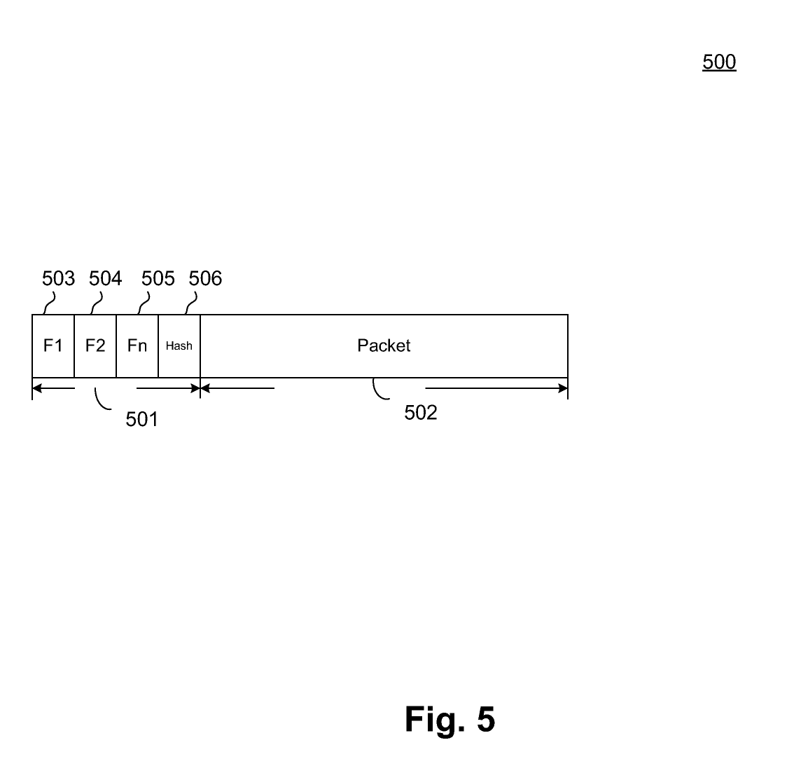

FIG. 5 shows an exemplary diagram 500 illustrating a packet 502 and a packet report 501 stored according to at least some embodiments of the invention. As shown in FIG. 5, a packet report 501 precedes a packet 502. As shown in FIG. 5, packet report 501 has, e.g., fields 503, 504, 505. As shown in FIG. 5, packet report 501 has a field 506 that contains a hash value. In at least some embodiments, a hash value is calculated based on the values in at least one of the packet header fields. In at least some embodiments, the hash value is calculated by a network processing unit, such as network processing unit 302. In at least some embodiments, the calculated hash value is written with the packet contents to a location in memory so that the hash value and the corresponding packet contents are associated together.

In at least some embodiments, fields 503, 504, 505 include pointers into the packet for key features, for example, a source IP address, a destination IP address, a source port number, a destination port number, a protocol, and other packet key features. In at least some embodiments, the hash value is calculated and added to field 506, for example, by network processing unit 302.

In at least some embodiments, the hash value calculated based on the header fields includes the packet source and destination IP addresses, protocol, TCP/UDP source and destination port numbers, or any combination thereof. In at least some embodiments, the hash value is calculated based on numerical order of the IP addresses such that data to and from IP addresses of a particular protocol will produce the same hash, so that IP “conversations” will be routed to the same sub-channel. In at least some embodiments, a hash value indicates to which sub-channel the packet needs to be sent.

In at least some embodiments, the hash value includes a hash value of the packet's IP address. In at least some embodiments, network processing unit 302 is configured to compare the received packet data against a network traffic filter stored in a memory (e.g., in data structure 400). In at least some embodiments, the filter having the data that match to the data of the packet is selected from the plurality of filters stored in a memory (e.g., in data structure 400) for routing the packet to a process sub-channel in a memory. In at least some embodiments, network processing unit 302 is configured to route the received packet to a process sub-channel in a memory based on comparing, as described in further detail below. In at least some embodiments, network processing unit 302 is configured to determine a hash value. In at least some embodiments, network processing unit 302 is configured to select the process sub-channel based on the determined hash value, as described in further detail below.

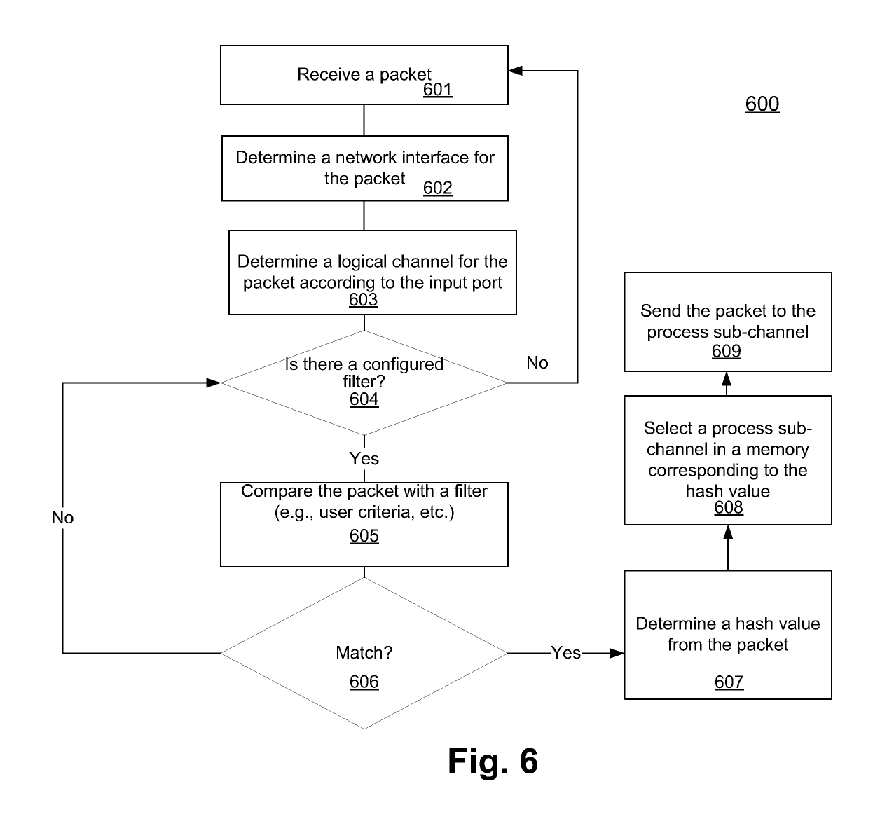

FIG. 6 is an exemplary flowchart of a method to split incoming data into a plurality of sub-channels according to at least some embodiments of the invention. At operation 601 a packet is received over a network. At operation 602 a network interface via which the packet is received is determined. In at least some embodiments, the packet is tagged for which port it came in on. At operation 603 the received packet is compared with a network traffic filter stored in a memory. In at least some embodiments, the filter includes user defined criteria for the packet, as described above. At operation 604 a determination is made if there is a configured filter (e.g., stored in a memory). If there is a configured filter, at operation 605 the packet is compared with the filter (e.g., user criteria, etc.). At operation 606 a determination is made whether the packet matches the filter. In one embodiment, if the packet matches the filter, method 600 continues with operation 607 that involves determining a hash value of the IP address contained in the header of the received packet. In at least some embodiments, if the packet matches the filter, a logical region in a memory that corresponds to the matched filter is selected. At operation 608 a process sub-channel in a memory that corresponds to the determined hash value is selected. In at least some embodiment, the process sub-channel is selected from a data structure, such as data structure 400. At operation 609 the packet is sent to the selected process sub-channel. If the packet does not match the filter, method 600 returns to operation 604 that determines if there is another configuration filter. If there is no configuration filter, method 600 returns to operation 601.

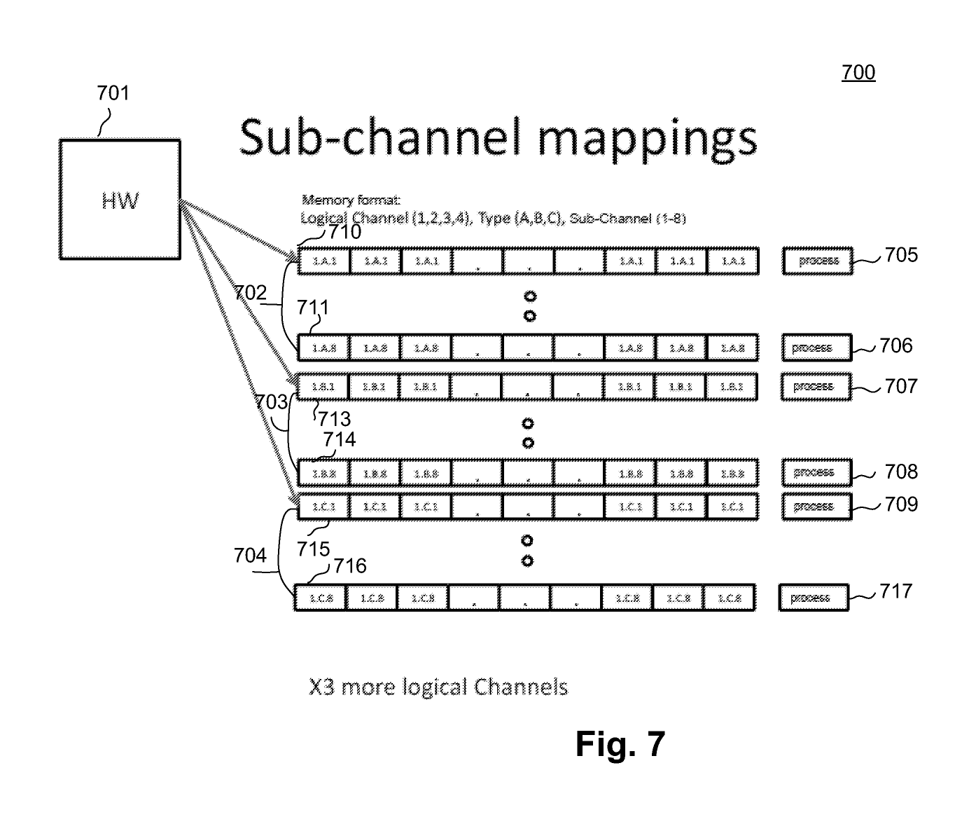

FIG. 7 shows an exemplary sub-channel mapping 700 for one of the logical channels (e.g., 1, 2, 3, 4) according to at least some embodiments of the invention. As shown in FIG. 7, a network processing unit 701 is configured to receive a packet stream from a network. In at least some embodiments, network processing unit 701 includes hardware. In one embodiment, network processing unit 701 is a part of a network analyzer, such as network analyzer 205, as described above. In at least some embodiments, network processing unit 701 is coupled to a plurality of logical channels (1, 2, 3, 4) that correspond to network interfaces of the network unit, as described above.

Network unit 701 is configured to route a packet to one of the logical regions, such as regions A, B and C that are selected based on user criteria, and other information contained in the packet, as described above. As shown in FIG. 7, region A contains First In, First Out data structures (“FIFOs”) 702, region B contains FIFOs 703, and region C contains FIFOs 704. Generally, a FIFO refers a queue data structure. The first data to be added to the queue will be the first data to be removed, then processing proceeds sequentially in the same order. Typically, computer networks use FIFOs to hold data packets in route to their next destination. In at least some embodiments, FIFOs 702 are packet analysis FIFOs, FIFOs 703 are both analysis and capture FIFOs, and FIFOs 704 are capture FIFOs.

As shown in FIG. 7, each of the logical regions 702, 703, and 704 has process sub-channels. The sub-channel is selected for routing based on the hash value calculated by network processing unit 302, as described above. As shown in FIG. 7, the sub-channels of logical region 702 are FIFOs, such as FIFOs 710 and 711, the sub-channels of logical region 703 are FIFOs, such as FIFOs 713 and 714, the sub-channels of logical region 704 are FIFOs, such as FIFOs 715 and 716. In at least some embodiments, each of the logical regions, such as logical regions 702, 703, and 704 contains a number of sub-channel FIFOs. In at least some embodiments, each of the logical regions, such as logical regions 702, 703, and 704 contains up to 8 sub-channel FIFOs. As shown in FIG. 7, the sub-channel FIFOs, such as FIFOs 710, 711, 713, 714, 715, and 716 are assigned to different processes, e.g., software processes 705, 706, 707, 708, 709, and 717 for simultaneous and independent processing of incoming data stream for application performance analysis, as described herein.

In the foregoing specification, embodiments of the invention have been described with reference to specific exemplary embodiments thereof. It will be evident that various modifications may be made thereto without departing from the broader spirit and scope of the embodiments of the invention. The specification and drawings are, accordingly, to be regarded in an illustrative sense rather than a restrictive sense.

What is claimed is:

1. A machine-implemented method to split incoming data into a plurality of sub-channels, comprising:
receiving a packet;
comparing the packet against a series of filters;
routing the packet to a process sub-channel in a memory based on the comparing.

2. The machine-implemented method of claim 1, further comprising
determining whether a filter matches to the packet, and
if the filter matches the packet, selecting a logical region that corresponds to the filter.

3. The machine-implemented method of claim 1, wherein at least one of the filters includes user defined criteria for the packet.

4. The machine-implemented method of claim 1, wherein the process sub-channel is one of the plurality of process sub-channels that are configured to allow parallel processing.

5. The machine-implemented method of claim 1, further comprising
determining a hash value of at least a portion of the packet, and
selecting the process sub-channel based on the hash value.

6. The machine-implemented method of claim 1, further comprising
determining a network interface of the packet; and
determining a logical channel in the memory based on the network interface.

7. The machine-implemented method of claim 1, at least one of the filters is a network traffic filter.

8. A non-transitory machine readable storage medium that has stored instructions which when executed cause a data processing system to perform operations comprising:
receiving a packet;
comparing the packet against series of filters;
routing the packet to a process sub-channel in a memory based on the comparing.

9. The non-transitory machine readable storage medium of claim 8, further comprising instructions that when executed cause the data processing system to perform operations comprising
determining whether a filter matches to the packet, and
if the filter matches to the packet,
selecting a logical region that corresponds to the filter.

10. The non-transitory machine readable storage medium of claim 8, wherein at least one of the filters includes user defined criteria for the packet.

11. The non-transitory machine readable storage medium of claim 8, wherein the process sub-channel is one of the plurality of process sub-channels that are configured to allow parallel processing.

12. The non-transitory machine readable storage medium of claim 8, further comprising instructions which when executed cause the data processing system to perform operations comprising
determining a hash value of at least a portion of the packet, and
selecting the process sub-channel based on the hash value.

13. The non-transitory machine readable storage medium of claim 8, further comprising instructions which when executed cause the data processing system to perform operations comprising
determining an network interface of the packet; and
determining a logical channel in the memory based on the network interface.

14. The non-transitory machine readable storage medium of claim 8, wherein at least one of the filters is a network traffic filter.

15. An apparatus to split incoming data into a plurality of sub-channels comprising:
a memory; and
a processing unit coupled to the memory, wherein the processing unit is configured to receive a packet, the processing unit configured to compare the packet against a series of filters, the processing unit configured to route the packet to a process sub-channel in a memory based on the comparing.

16. The apparatus of claim 15, wherein the processing unit is further configured to determine whether a filter matches with the packet, and if the filter matches the packet, the processing unit is configured to select a logical region that corresponds to the filter.

17. The apparatus of claim 15, wherein at least one of the filters includes user defined criteria for the packet.

18. The apparatus of claim 15, wherein the process sub-channel is one of the plurality of process sub-channels that are configured to allow parallel processing.

19. The apparatus of claim 15, wherein the processing unit is further configured to
determine a hash value of at least a portion of the packet, and to select the process sub-channel based on the hash value.

20. The apparatus of claim 15, wherein the processing unit is further configured to
determine a network interface of the packet, and to determine a logical channel in the memory based on the network interface.
